(19) United States
(12) Patent Application Publication
(10) Pub. No.: US 2023/0193759 A1
(43) Pub. Date: Jun. 22, 2023

(54) EXPANDER SYSTEMS FOR HARNESSING ENERGY FROM PRESSURIZED FLUID FLOW

(71) Applicant: CNX Resources Corporation, Canonsburg, PA (US)

(72) Inventors: Kevin Robert Egeland, Pittsburgh, PA (US); Joseph M. Fink, Washington, PA (US)

(21) Appl. No.: 17/559,343

(22) Filed: Dec. 22, 2021

(51) Int. Cl. F02G 1/044; F02G 1/055; E21B 41/00

(52) U.S. Cl. CPC F02G 1/044; F02G 1/055; E21B 41/0085; F02G 2280/50

(57) ABSTRACT

A system includes a reciprocating expander including: a piston disposed in a chamber; a crankshaft; a connector rod coupled between the piston and the crankshaft and configured to transfer torque to the crankshaft in response to movement of the piston in the chamber; and a fluid inlet and a fluid outlet on one side of the piston. The system also includes a first flowpath coupled between a wellbore and the reciprocating expander and configured to communicate gas from the wellbore into the fluid inlet of the reciprocating expander at a first pressure. The system further includes a second flowpath coupled between the reciprocating expander and downstream equipment and configured to communicate the gas from the reciprocating expander toward the downstream equipment at a second pressure, the second pressure being lower than the first pressure.

### TECHNICAL FIELD

The present invention relates to reciprocating expanders and systems for harnessing energy from a pressurized fluid flow using a reciprocating expander to power one or more downstream processes.

### BACKGROUND

Turbo expanders are conventionally used to harness energy from pressurized fluid flows. A turbo expander receives a pressurized fluid stream through its inlet and directs the fluid stream into contact with an expansion turbine, which expands the fluid stream to produce work used to drive other operations. Turbo expanders convert changes in the pressure of the fluid flow into rotational energy that can be used to power other processes, such as compression, power generation, liquefication of gas and the like.

Turbo expanders may be used in natural gas processing operations to convert energy from “clean” natural gas streams. Modern natural gas and oil wells generate tremendous pressure during early production, in some cases approaching 20,000 psig (pounds per square inch, gauge pressure). As technology continues to advance in the field of natural gas production, wellhead gas is being conditioned into clean natural gas streams at increasingly higher pressures.

Unfortunately, turbo expanders that can recover energy from fluid flows at pressures above 3,000 psig are not commonly manufactured. Moreover, turbo expanders can operate very efficiently within a limited range of operating conditions, but over a broad range of conditions their efficiency will suffer. In order to capture an economically useful amount of pressure energy during the early production period of a well (where wellhead pressures may begin at around 10,000 psig and eventually fall to a pipeline pressure of around 1,000 psig), an expander should ideally be able to accept a very high pressure inlet stream and operate at a reasonable efficiency over a broad range of expansion ratios.

### SUMMARY

Embodiments of the present disclosure are directed to a system, including: a reciprocating expander, including: a piston disposed in a chamber; a crankshaft; a connector rod coupled between the piston and the crankshaft and configured to transfer torque to the crankshaft in response to movement of the piston in the chamber; and a fluid inlet and a fluid outlet on one side of the piston; a first flowpath coupled between a wellbore and the reciprocating expander and configured to communicate gas from the wellbore into the fluid inlet of the reciprocating expander at a first pressure; and a second flowpath coupled between the reciprocating expander and downstream equipment and configured to communicate the gas from the reciprocating expander toward the downstream equipment at a second pressure, the second pressure being lower than the first pressure.

Other embodiments of the present disclosure are directed to a system, including: a reciprocating expander, including: a piston disposed in a chamber; a crankshaft; a connector rod coupled between the piston and the crankshaft and configured to transfer torque to the crankshaft in response to movement of the piston in the chamber; and a fluid inlet and a fluid outlet on one side of the piston, wherein the reciprocating expander is configured to receive fluid at a first pressure and to output the fluid at a second pressure, the second pressure being lower than the first pressure; and a compressor connected to the reciprocating expander, wherein the compressor receives operating power from the reciprocating expander to compress another fluid stream.

Other embodiments of the present disclosure are directed to a system, including: a reciprocating expander including a first reciprocating expander stage and a second reciprocating expander stage, wherein the first reciprocating expander stage has a first fluid inlet and a first fluid outlet, and the second reciprocating expander stage has a second fluid inlet and a second fluid outlet; a heat exchanger coupled between the first fluid outlet and the second fluid inlet, wherein the heat exchanger is configured to raise the temperature of gas flowing from the first fluid outlet to the second fluid inlet via heat exchange with ambient air or another fluid; a first flowpath coupled to the reciprocating expander for providing gas from a wellbore to the reciprocating expander; and a second flowpath coupled to the reciprocating expander for providing gas from the reciprocating expander to downstream equipment at a second pressure.

Other embodiments of the present disclosure are directed to a system, including: an expander; a compressor coupled to the expander and configured to receive operating power from the expander; a generator coupled to the expander and configured to generate electricity via rotation of the generator by the expander; and one or more components of electrolysis equipment coupled to the generator and configured to receive the electricity from the generator and to generate hydrogen gas via the electricity, wherein: the electrolysis equipment is coupled to the compressor for inputting the hydrogen gas generated via the electrolysis equipment into the compressor, and the compressor compresses the hydrogen gas.

These and other features and characteristics of a system including an expander (e.g., a reciprocating expander) will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular forms of “a”, “an”, and “the” include plural referents unless the context clearly dictates otherwise.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a schematic block diagram of a system using a reciprocating expander to provide power to downstream equipment, in accordance with an embodiment of the present disclosure;

FIG. 2 is a schematic block diagram of a system using a multi-stage reciprocating expander to provide power to downstream equipment, in accordance with an embodiment of the present disclosure;

FIG. 3 is schematic partial cross-sectional view of a reciprocating expander, in accordance with an embodiment of the present disclosure;

FIGS. 4 and 5 are schematic block diagrams of systems using a reciprocating expander to power a compressor, in accordance with an embodiment of the present disclosure;

FIG. 6 is a schematic block diagram of a system using a reciprocating expander to power both a compressor and one or more other downstream components, in accordance with an embodiment of the present disclosure;

FIGS. 7 and 8 are schematic block diagrams of systems using an expander to power one or more compressors used to compress product(s) of an electrolysis process, in accordance with an embodiment of the present disclosure;

FIGS. 9 and 10 are schematic block diagrams of systems using a multi-stage reciprocating expander with at least one heat exchanger between different stages, in accordance with an embodiment of the present disclosure; and

FIGS. 11 and 12 are schematic block diagrams of systems using a multi-stage reciprocating expander to power a multi-stage compressor and exchanging heat between the expander and the compressor, in accordance with an embodiment of the present disclosure.

### DETAILED DESCRIPTION

Disclosed embodiments are directed to systems and methods in which a reciprocating expander is used to harness energy from a pressurized fluid flow. The pressurized fluid flow may be a gas flow (e.g., a substantially clean gas flow). The pressurized fluid flow may be a pressurized flow of natural gas. The systems disclosed herein may be used to capture energy from a fluid stream having a pressure above, for example, 1,500 psig, more particularly above 2,500 psi, or more particularly above 5,000 psig. The systems may be used to capture energy from a gas producing well. In some embodiments, the reciprocating expander may be rated, designed, or configured for, or be capable of, operating at input gas pressures as high as or greater than an unregulated pressure at which gas flows from a wellbore. For example, unregulated gas pressure at the wellhead of Marcellus Shale formation wells may be approximately 5,000 psi, and unregulated gas pressure at the wellhead of Utica Shale formation wells may be approximately 10,000 psi. In other embodiments, the reciprocating expander may be rated, designed, or configured for, or be capable of, operating at regulated input gas pressures. For example, the gas pressure of a Utica Shale formation well may be regulated down from approximately 10,000 psi at the wellhead to approximately 5,000 psi before being conditioned and fed to the reciprocating expander.

The disclosed reciprocating expanders may include a piston disposed in a chamber, a crankshaft, a connector rod coupled between the piston and the crankshaft and configured to transfer torque to the crankshaft in response to movement of the piston in the chamber, and a fluid inlet and a fluid outlet on one side of the piston. As such, the disclosed reciprocating expanders have a similar structure to that of a reciprocating compressor, but operated in reverse (e.g., as a positive displacement expander). In particular, the reciprocating expanders use the high-pressure fluid flow to generate electricity and/or provide torque to other equipment. Reciprocating expanders having a construction similar to or equivalent to a gas compressor operated in reverse may enable the conversion of pressure energy in a fluid stream to mechanical energy in a crankshaft at economically useful efficiencies over a broader range of expansion ratios than is possible using turbomachinery.

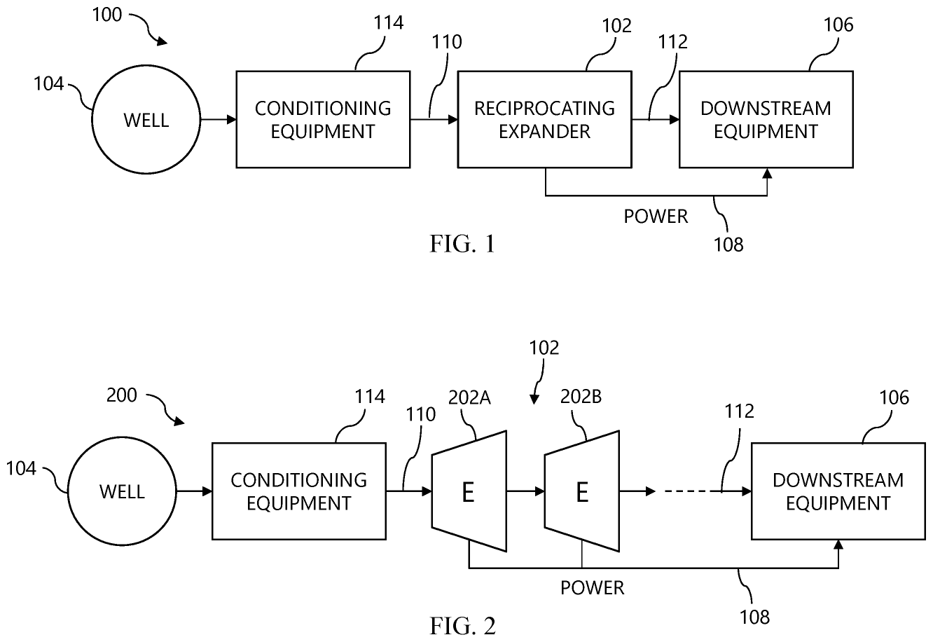

Turning now to the drawings, FIG. 1 depicts an example system 100 having a reciprocating expander 102 in accordance with the present disclosure. As illustrated, the reciprocating expander 102 may be connected between a wellbore 104 and one or more pieces of downstream equipment 106. The well 104 may be a natural gas well. Pressurized gas extracted from the wellbore 104 may be input to the reciprocating expander 102 and expanded via the reciprocating expander 102 to reduce the pressure of the gas stream and output power 108 for operating one or more pieces of the downstream equipment 106.

In present embodiments, the reciprocating expander 102 may generally include a piston disposed in a chamber, a crankshaft, and a connector rod coupled between the piston and the crankshaft. The connector rod is configured to transfer torque to the crankshaft in response to movement of the piston in the chamber. The reciprocating expander 102 further includes a fluid inlet and a fluid outlet. An exemplary arrangement of these components of the reciprocating expander 102 is shown and described in detail below with reference to FIG. 3. The reciprocating expander 102 may have essentially the structure of a reciprocating gas compressor that is arranged and operated in reverse as a positive displacement expander (e.g., receiving high pressure fluid and outputting a reduced pressure fluid stream).

The system 100 of FIG. 1 may further include at least one flowpath (“first flowpath”) 110 coupled between the wellbore 104 and the reciprocating expander 102 and at least one flowpath (“second flowpath”) 112 coupled between the reciprocating expander 102 and the downstream equipment 106. The first flowpath 110 may be configured to communicate gas from the wellbore 104 into the fluid inlet of the reciprocating expander 102 at a first pressure. The first pressure may be at least 1,500 psig. To that end, the first flowpath 110 may be rated for 1,500 psig, more particularly 2,500 psig, or more particularly 5,000 psig or greater.

In some embodiments, the system 100 may also include one or more pieces of conditioning equipment 114 coupled along the first flowpath 110. The conditioning equipment 114 is configured to condition the gas output from the wellbore 104 for input to the reciprocating expander 102. For example, the conditioning equipment 114 may include one or more separators, filters, dehydrators (e.g., molecular dryers), CO₂ removal equipment, or any other desired equipment configured to condition the gas stream extracted from the wellbore 104 (e.g., by removing contaminants from the gas stream). Removing liquid, sand, debris, particulate, water vapor, CO₂, and/or other contaminants from the gas stream enables the pressurized gas stream to enter the reciprocating expander 102 without these contaminants that might otherwise clog, freeze, impact, or cause other damage to components of the reciprocating expander 102. The conditioning equipment 114 may include a separator that allows for separation of fluid, sand, and debris from the gas stream at pressures available at the wellbore (e.g., prior to gas pressure reduction). Removing these and other contaminants from the gas stream without significantly reducing the pressure of the gas stream may enable the reciprocating expander 102 to effectively harness energy from the high-pressure gas flow to power (108) downstream equipment. This may help to ensure that the high pressure of the gas extracted from the wellbore 104 does not go to waste, but instead is used as a zero-emissions power source.

The second flowpath 112 may be configured to communicate the gas from the reciprocating expander 102 toward one or more pieces of downstream equipment 106 at a second pressure, the second pressure being lower than the first pressure. The second pressure may be between approximately 800 psig and 1,200 psig, or more particularly about 1,000 psi. The reciprocating expander 102 may output power 108 (e.g., electrical power, mechanical power, etc.) to one or more pieces of downstream equipment 106 as well. The power 108 may be used to operate one or more pieces of downstream equipment 106. In some embodiments, the power 108 may be used to operate one or more pieces of equipment that also receive the reduced pressure gas stream output from the reciprocating expander 102. The downstream equipment 106 may include any combination of one or more of the following: a compressor, a pipeline, a compressed natural gas (CNG) filling station, liquefied natural gas (LNG) production equipment, electrolysis process equipment, heating/cooling equipment, an electric grid, cryptocurrency mining hardware, or any other desired equipment that may make use of the reduced pressure gas stream and/or the power output from the reciprocating expander 102. Various examples of downstream equipment components are described in detail below.

FIG. 2 depicts another example system 200 having a reciprocating expander 102 in accordance with the present disclosure. Similar to FIG. 1, the reciprocating expander 102 may be connected between a wellbore 104 and one or more pieces of downstream equipment 106. As illustrated in FIG. 2, the reciprocating expander 102 may be a multi-stage reciprocating expander having at least a first expander stage 202A and a second expander stage 202B. Each of the first and second expander stages 202A and 202B may include: a piston disposed in a chamber; a crankshaft; a connector rod coupled between the piston and the crankshaft and configured to transfer torque to the crankshaft in response to movement of the piston in the chamber; a fluid inlet; and a fluid outlet. The crankshaft may be the same or different for two or more stages (e.g., 202A/B) of the reciprocating expander 102. The reciprocating expander 102 may have any desired number of stages (e.g., 202A/B), such as one, two, three, four, five, six, seven, eight, nine, ten, or more stages.

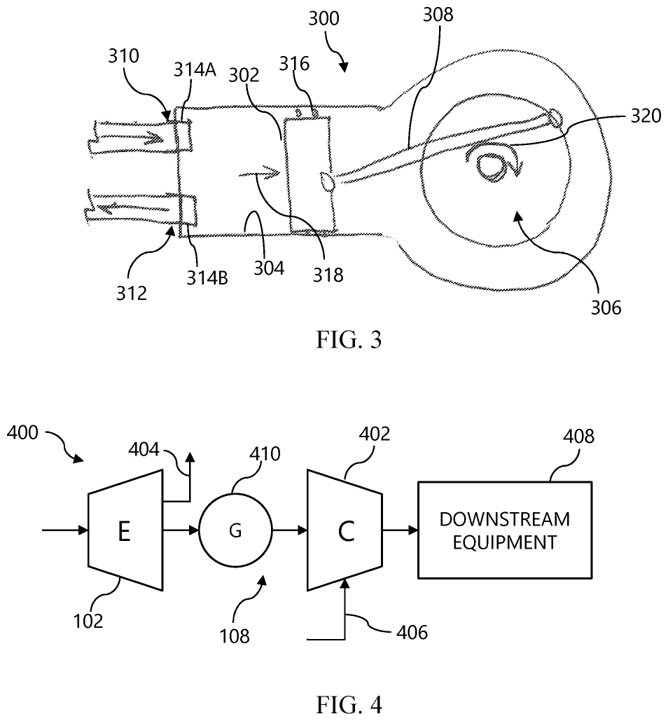

The expander stages 202 in a multi-stage reciprocating expander 102 are fluidly coupled in series with one another to provide successive pressure reductions of the fluid stream moving therethrough. For example, a fluid outlet of the first expander stage 202A may be configured to output the fluid stream (e.g., gas) to a fluid inlet of the second expander stage 202B at an intermediate pressure between the first pressure at which the fluid stream enters the reciprocating expander 102 and the second pressure at which the fluid stream exits the reciprocating expander 102. Each expander stage 202 may provide additional power 108 to the downstream equipment 106. In the system 200 of FIG. 2, the first flowpath 110 is coupled between the wellbore 104 and the first stage 202A of the reciprocating expander 102, and the second flowpath 112 is coupled between the final stage (e.g., 202B) of the reciprocating expander 102 and the downstream equipment 106. In the embodiments of FIGS. 4-8, the reciprocating expander 102 may be a multi-stage reciprocating expander as shown in FIG. 2.

FIG. 3 illustrates the inner workings of a single expander stage 300 in accordance with the disclosed embodiments. In an example, the expander stage 300 may be the only stage of the reciprocating expander (e.g., 102 of FIG. 1). In another example, each of multiple stages (e.g., 202A, 202B, etc. of FIG. 2) of the reciprocating expander may take the form of the expander stage 300. The expander stage 300 includes a piston 302 disposed in a chamber 304, a crankshaft 306, a connector rod 308, a fluid inlet 310, and a fluid outlet 312. As illustrated, the connector rod 308 may be coupled at a first end to the piston 302 (either directly or through one or more other components like a crosshead, piston rod, etc.) and the connector rod 308 may be coupled at its opposite end to the crankshaft 306. One or more controllable valves (e.g., 314A/B) may be present at, proximate, or remote from the interfaces of the fluid inlet 310/fluid outlet 312 with the chamber 304. In some embodiments, the inlet valve 314A may be located further upstream from the fluid inlet 310 (e.g., along flowpath 110 of FIG. 1) than is shown. Likewise, the outlet valve 314B may be located further downstream from the fluid outlet 312 (e.g., along flowpath 112 of FIG. 1) than is shown. One or more seals 316 may be present between the outer edge of the piston 302 and the inner wall of the chamber 304.

An exemplary operation of the reciprocating expander will now be described. In a first half stroke of the reciprocating expander stage 300, the valve 314A may be open while the valve 314B is closed. As a result, high-pressure fluid flows (e.g., from flowpath 110 of FIG. 1) through the open valve 314A and enters the chamber 304 through the fluid inlet 310. The fluid stream expands as it pushes the piston 302 longitudinally through the chamber 304 (arrow 318). This reduces the pressure of the fluid in the chamber 304. The connector rod 308 transfers the longitudinal movement of the piston 302 into rotational movement (arrow 320) of the crankshaft 306. In a second half stroke of the reciprocating expander stage 300, the valve 314A may be closed while the valve 314B is open. The lower pressure fluid begins to exit the chamber 304 through the fluid outlet 312, and the crankshaft 306 continues to turn such that the connector rod pushes back against the piston 302 forcing the piston 302 in the opposite longitudinal direction. The expanded, lower pressure fluid in the chamber 304 exits the fluid outlet 312 (e.g., via open valve 314B) as the piston 302 reaches its starting position in the chamber 304. This process then repeats itself with a new portion of the incoming pressurized fluid stream. The connector rod transfers torque to the crankshaft 306 in response to the reciprocating movement of the piston 302, e.g., throughout the entire stroke of the reciprocating expander stage 300.

The reciprocating expander stage 300 illustrated in FIG. 3 is exemplary, and many variations of the construction of the reciprocating expander may be possible without departing from the scope of the present disclosure.

In some embodiments, the reciprocating expander 102 disclosed herein may be used in combination with a compressor. For example, FIGS. 4-6 illustrate systems 400/500/600 in which the reciprocating expander 102 supplies operational power 108 to a compressor 402. The compressor 402 may be a single stage compressor or a multi-stage compressor having two, three, four, five, six, seven, eight, nine, ten, or more stages. In some embodiments, the compressor 402 may be a reciprocating compressor having a similar structure to the reciprocating expander stage 300 of FIG. 3 but operating in reverse (e.g., transferring torque from a crankshaft to reciprocating motion of piston(s) to compress a fluid flow). The compressor 402 may compress (pressurize) a separate fluid stream 406 than the fluid stream 404 that is expanded by the reciprocating expander 102, as shown. The compressor 402 may output its pressurized fluid stream to one or more additional downstream equipment components 408.

In each of FIGS. 4-6, the compressor 402 is coupled to the reciprocating expander 102 and configured to receive operating power 108 from the reciprocating expander 102. As shown in FIG. 4, the compressor 402 may be electrically powered by the reciprocating expander 102. To that end, the system 400 may include a generator 410 (e.g., an electric power generator) that is coupled to the crankshaft (e.g., 306 of FIG. 3) of the reciprocating expander 102. The generator 410 may be mechanically coupled to the crankshaft (306 of FIG. 3) of the reciprocating expander 102, either directly or through a connection with one or more intermediate components. The generator 410 is configured to generate electricity used to electrically power (108) the compressor 402. The generator 410 may be electrically coupled to the compressor 402 for supplying the electrical power to the compressor 402. The electricity may be supplied to a motor of the compressor 402 and used to power the motor to rotate a shaft of the compressor 402, thereby operating the compressor 402. In operation, the pressure letdown through the reciprocating expander 102 from the high-pressure fluid stream turns the crankshaft (306 of FIG. 3) of the expander 102, thereby providing rotational energy to the generator 410. The generator 410 converts the rotational energy to electricity supplied to the compressor 402.

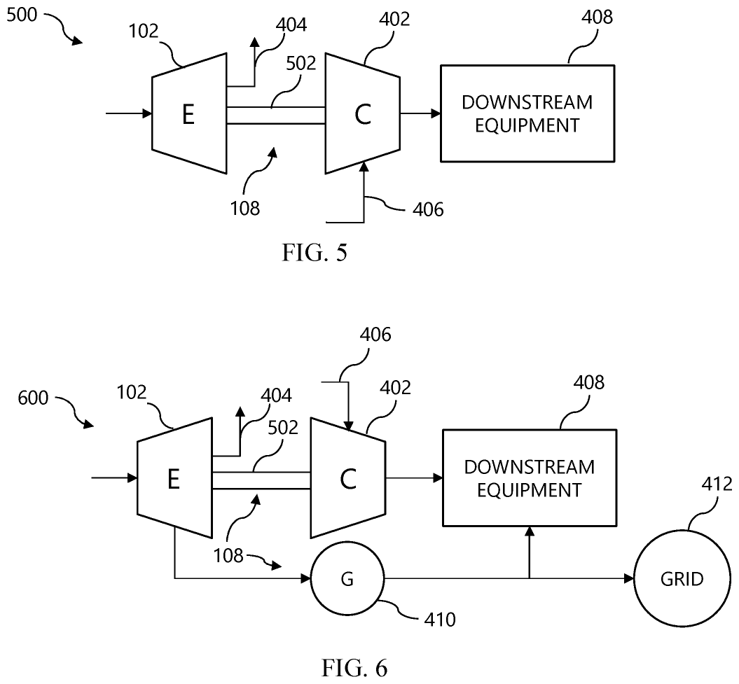

As shown in FIG. 5, the compressor 402 may be mechanically powered by the reciprocating expander 102. To that end, the system 500 may include a compressor 402 that is physically coupled to the crankshaft (e.g., 306 of FIG. 3) of the reciprocating expander 102 such that the reciprocating expander 102 mechanically powers the compressor 402. In an example, the compressor 402 may be directly coupled to the crankshaft (306 of FIG. 3) of the reciprocating expander 102. In another example, as illustrated, the compressor 402 may be coupled to the crankshaft (306 of FIG. 3) via one or more intermediate shafts 502, flanges, or other components. The reciprocating expander 102 may rotate (e.g., via shaft 502) a drive shaft of the compressor 402. In operation, the pressure letdown through the reciprocating expander 102 from the high-pressure fluid stream turns the crankshaft 306 of the expander 102, thereby providing rotational energy to directly power (108) the compressor 402 by turning the drive shaft of the compressor 402.

As shown in FIG. 6, the reciprocating expander 102 may provide operational power 108 to the compressor 402 in addition to at least one other component of downstream equipment 408. As shown, the downstream equipment 408 that is powered by the reciprocating expander 102 may be configured to condition and/or perform work on the fluid stream 406 once it is compressed and output from the compressor 402. Additionally or alternatively, the downstream equipment component 408 that is powered by the reciprocating expander 102 may be configured to condition and/or perform work on the fluid stream 404 once it is expanded and output from the reciprocating expander 102.

As illustrated, the reciprocating expander 102 may be both physically coupled (e.g., via shaft 502) to the compressor 402 to turn the compressor 402 and physically coupled to a generator 410 to turn the generator 410 for electricity production. The reciprocating expander 102 may include a multi-stage reciprocating expander (as shown in FIG. 2) with one expander stage used to turn the generator 410 and the other used to turn the compressor 402. The electricity generated by the generator 410 may be used to electrically power one or more components of the downstream equipment 408 and/or to supply electricity to a grid 412. In other embodiments, the methods for providing operational power 108 to the compressor 402/other downstream equipment 408 from the reciprocating expander 102 may be reversed. That is, the reciprocating expander 102 may be physically coupled (e.g., via shaft 502) to the downstream equipment component(s) 408 and physically coupled to a generator 410 that generates and provides electricity for operating the compressor 402. In still other embodiments, the methods for providing operational power 108 to the compressor 402/other downstream equipment 408 from the reciprocating expander 102 may both be the same. That is, the reciprocating expander 102 may be coupled to both the compressor 402 and the downstream equipment 408 through a drive train to provide mechanical power to both the compressor 402 and other downstream equipment 408. As another example, the reciprocating expander 102 may be coupled to a generator 410 that provides electrical operating power to both the compressor 402 and the other downstream equipment 408.

Any type of expander (including a reciprocating expander 102) may be useful in harnessing energy from a high-pressure fluid stream for production of more “green” forms of energy. For example, in the production of hydrogen for use as an energy source, the process requires both electricity for an electrolysis operation to separate hydrogen from oxygen, and compression of the hydrogen to a pressure (e.g., 3,000-5,000 psig) suitable for transport. FIG. 7 depicts an example system 700 that uses an expander 701 (e.g., the reciprocating expander 102) to produce both electricity for an electrolysis process 702 and the means to transport hydrogen 704 output from the electrolysis process 702 in one package. The electrolysis process 702 may include one or more components of electrolysis equipment such as, for example, proton exchange membrane electrolyzers, alkaline electrolyzers, or solid oxide electrolyzers.

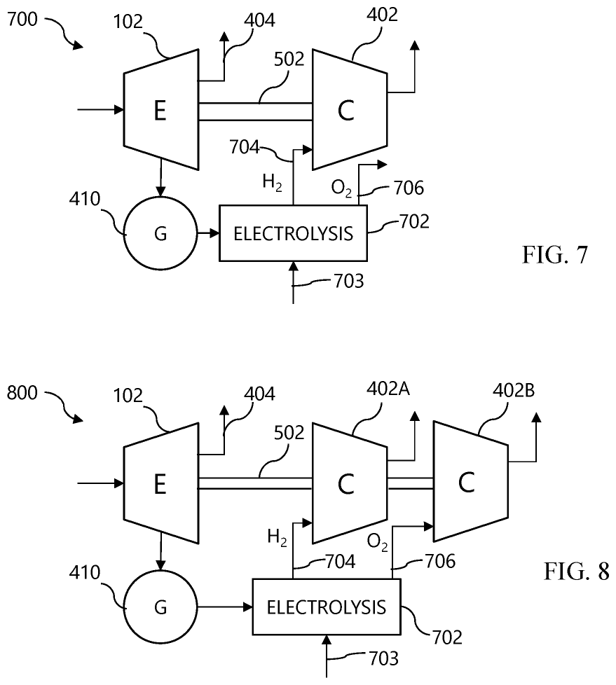

The system 700 of FIG. 7 includes a compressor 402 coupled to the expander 701, 102. As discussed at length above, the compressor 402 may be mechanically powered by the reciprocating expander (e.g., via shaft 502 as shown) or electrically powered by the reciprocating expander. A generator 410 may be coupled to the crankshaft (e.g., 306 of FIG. 3) of the expander 701, 102 and configured to generate electricity used to power the electrolysis process 702. In the electrolysis process 702, water (H₂O) 703 may be separated into hydrogen gas (H₂) and oxygen gas (O₂) using the electricity input to the process 702. The electrolysis process 702 may generate hydrogen gas 704 and oxygen gas 706 as products. The hydrogen gas 704 and oxygen gas 706 may be output at pressures between approximately 300 psig and 500 psig, more particularly at about 400 psig. To transport and fill tanks, however, the hydrogen gas 704 and/or oxygen gas 706 may need to be pressurized to approximately 10,000 psig. As illustrated, the hydrogen gas 704 output from the electrolysis process 702 may be input to the compressor 402, which pressurizes the hydrogen gas 704 to the desired transportation pressure (e.g., about 10,000 psig). In other embodiments, the oxygen gas 706 output from the electrolysis process 702 may be input to the compressor 402, which pressurizes the oxygen gas 706 to a desired transportation pressure. In still other embodiments, as shown in FIG. 8, a system 800 may include two compressors 402A and 402B that may receive operating power (e.g., via shaft 502, or electrically) from the expander 701, 102. One compressor 402A may pressurize the hydrogen gas 704 output from the electrolysis process 702 to a desired transportation pressure, while the other compressor 402B pressurizes the oxygen gas 706 output from the electrolysis process 702 to a desired transportation pressure.

In the above descriptions of FIGS. 7 and 8, the expander 701 is described as being a reciprocating expander 102. However, any desired type of expander 701 may be used to produce both electricity for an electrolysis process 702 and the means to transport hydrogen 704 output from the electrolysis process 702 in one closed loop package. For example, the expander 701 may include a turbo expander or turbine in other embodiments. Any other type of expansion mechanism capable of transferring a pressure to torque through expansion of a pressurized fluid may be used to perform the electrolysis process 702 and compress the resulting gas(es), as described above.

In systems where the reciprocating expander 102 comprises multiple expansion stages, thermal regulation of the fluid stream moving through the multi-stage expander 102 may increase the efficiency of harnessing energy from the pressure letdown. Specifically, heating the fluid stream between the different expander stages incrementally increases the amount of energy that can be harnessed through the expansion process. With pressure letdown, there is a cooling effect on the expanded fluid stream.

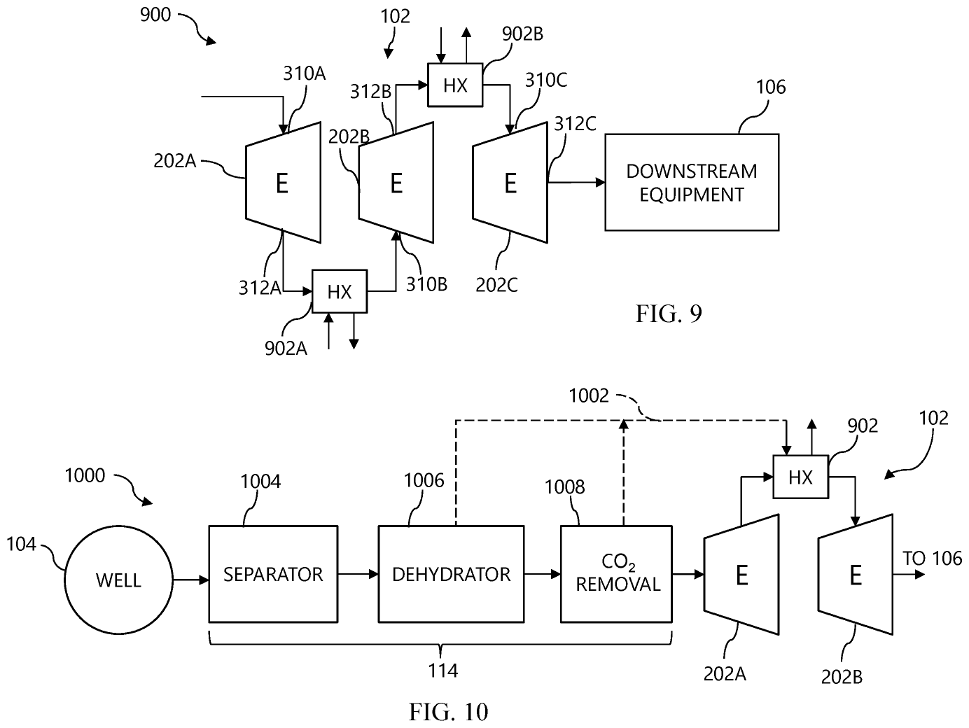

FIG. 9 depicts an example system 900 having a multi-stage reciprocating expander 102 and heat exchangers 902 disposed between adjacent expander stages 202. The illustrated system 900 includes a first heat exchanger 902A located between a first expander stage 202A and a second expander stage 202B, and a second heat exchanger 902B located between the second expander stage 202B and a third expander stage 202C. In other embodiments, a heat exchanger 902 may be coupled between more than two expander stages. The multi-stage reciprocating expander 102 may include n expander stages 202, and the system 900 may include up to n−1 heat exchangers 902 located between adjacent expander stages 202. Each heat exchanger 902 is configured to heat the gas flowing from one expander stage (e.g., 202A) to an adjacent expander stage (e.g., 202B). In the illustrated embodiment of FIG. 9, a first reciprocating expander stage 202A has a first fluid inlet 310A and a first fluid outlet 312A, a second reciprocating expander stage 202B has a second fluid inlet 310B and a second fluid outlet 312B, and a third reciprocating expander stage 202C has a third fluid inlet 310C and a third fluid outlet 312C. The heat exchanger 902A is coupled between the first fluid outlet 312A and the second fluid inlet 310B and the heat exchanger 902B is coupled between the second fluid outlet 312B and the third fluid inlet 310C. The heat exchanger 902A may be configured to raise the temperature of the fluid (e.g., gas) flowing from the first fluid outlet 312A to the second fluid inlet 310B. Similarly, the heat exchanger 902B may be configured to raise the temperature of the fluid (e.g., gas) flowing from the second fluid outlet 312B to the third fluid inlet 310C. Each heat exchanger 902 may include any desired type, construction, or arrangement of heat exchanger(s) capable of heating the fluid stream moving through the stages 202 of the reciprocating expander 102.

In some embodiments, one or more of the heat exchangers 902 may include ambient heat exchangers. That is, the heat exchangers 902 may use ambient air to heat the fluid stream moving through the reciprocating expander 102. This may be beneficial in environments having relatively high ambient air temperatures, for example, located nearby wells or other sources of pressurized fluid streams. For example, areas such as the Marcellus shale formation or Haynesville shale formation may provide large quantities of natural gas production at high pressures (e.g., 2,500-5,000 psig) in the United States while providing exposure to hot ambient/outdoor temperatures. As such, a multi-stage reciprocating expander 102 may be used to harness energy from the high-pressure gas streams in a more efficient manner by simply exposing the inter-stage gas stream to high ambient temperatures via heat exchanger(s) 902, since heating the gas stream increases the amount of energy that can be harnessed through the expansion process.

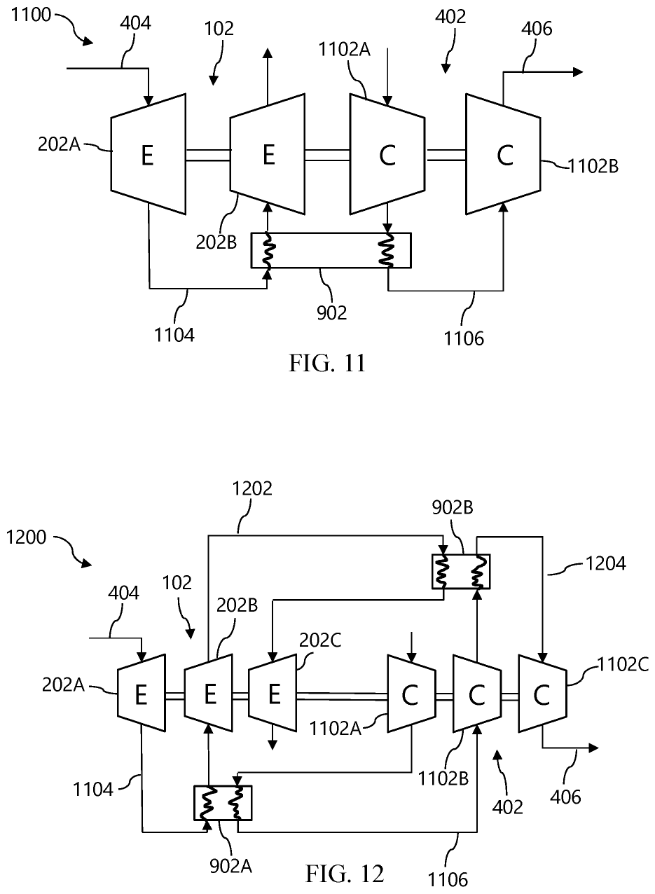

In other embodiments, one or more of the heat exchangers 902 may be configured to raise the temperature of gas flowing between one reciprocating expander stage 202 and the next via heat exchange with another fluid other than ambient air. In particular, the heat exchanger(s) 902 may make use of one or more heated process fluids present in the overall system. The heated process fluid may use heat generated from other processes, such as conditioning a gas stream (e.g., FIG. 10), an electrolysis process (e.g., FIGS. 7 and 8), compression (e.g., FIGS. 11 and 12), or any other process in the system. FIG. 10 is an example system 1000 in which a heated process fluid 1002 output from one or more components of the conditioning equipment 114 between a wellbore 104 and the reciprocating expander 102 may be used in the inter-stage heat exchanger(s) 902. The conditioning equipment 114 may include, for example, a separator 1004 configured to remove fluid, sand, and/or debris from the pressurized gas stream extracted from the wellbore 104, a dehydrator (e.g., molecular dryer) 1006 for removing water vapor from the pressurized gas stream, and/or a CO₂ removal system 1008 for removing CO₂ from the pressurized gas stream. This conditioning equipment 114 may output a substantially “clean” pressurized gas flow to the reciprocating expander 102.

A heated process fluid 1002 may be output from the dehydrator 1006, the CO₂ removal system 1008, or both. For example, one or both of the dehydrator 1006 and the CO₂ removal system 1008 may use a temperature swing adsorption (TSA) process to remove water vapor or CO₂ from the gas stream. In a TSA process, the gas stream enters an adsorption vessel, which adsorbs the contaminant(s) (e.g., water, CO₂) from the gas stream. Such adsorption vessels are periodically regenerated by raising the temperature of the adsorbent, which typically involves purging the bed with a preheated gas. This gas used in the TSA regeneration process (“TSA regeneration gas”) may be directed to the inter-stage heat exchanger(s) 902 of the reciprocating expander 102. As such, the heat exchanger(s) 902 may use a TSA regeneration gas as a heated process fluid 1002 to raise the temperature of the fluid (e.g., gas) flowing from one expander stage 202A to another 202B. It should be noted that other heated process fluids 1002 provided from one or more other locations in the system 1000 and/or downstream equipment 106 may be directed to the heat exchanger(s) 902 for heating the fluid stream between adjacent expander stages 202.

Using the reciprocating expander 102 in combination with a compressor 402 may improve efficiency of both the expansion and compression processes by taking advantage of the thermal effects of each component. As mentioned above, with pressure letdown, there is a cooling effect on the gas stream. Similarly, in a compression cycle, a large amount of heat is generated. The temperature changes from each of these processes can be used to compensate for each other and to improve the efficiency of each process. Specifically, the heat generated from the compression may be used to heat the fluid stream flowing through the reciprocating expander 102, while the cooling provided by the reciprocating expander may be used to cool the fluid stream flowing through a multi-stage compressor.

FIGS. 11 and 12 depict example systems 1100 and 1200 in which inter-stage heat exchangers 902 make use of the thermal effects between the reciprocating expander 102 and compressor 402. In FIG. 11, the reciprocating expander 102 has a first expander stage 202A and a second expander stage 202B. Similarly, the compressor 402 may be a reciprocating compressor having a first compressor stage 1102A and a second compressor stage 1102B. As discussed above, separate fluid streams 404 and 406 may be moving through the reciprocating expander 102 and the compressor 402, respectively. As discussed above with reference to FIGS. 4-6, the reciprocating expander 102 may provide operating power 108 to the compressor 402, for example, via mechanical coupling through one or more shafts or via electricity provided from an electric generator turned by the expander 102.

As illustrated, the system 1100 includes a heat exchanger 902 configured to receive and exchange heat between the two fluid streams 404 and 406 flowing through the expander 102 and the compressor 402, respectively. The system 1100 may include a flowpath 1104 between the pair of stages 202A and 202B of the multi-stage reciprocating expander 102, this flowpath 1104 passing through the heat exchanger 902. The system 1100 may also include a flowpath 1106 between the pair of stages 1102A and 1102B of the multi-stage compressor 402, this flowpath 1106 passing through the heat exchanger 902. The heat exchanger 902 is configured to heat the gas flowing between the two stages 202A and 202B of the reciprocating expander 102 via fluid moving through the compressor 402, while cooling the fluid flowing between the compressor stages 1102A and 1102B via the gas flowing through the expander 102.

The structure and operations of the system 1100 of FIG. 11 may be extended to systems in which the reciprocating expander 102/compressor 402 have any number of stages greater than two. For example, in the system 1200 of FIG. 12, the reciprocating expander 102 has a first expander stage 202A, a second expander stage 202B, and a third expander stage 202C. Similarly, the reciprocating compressor 402 may have a first compressor stage 1102A, a second compressor stage 1102B, and a third compressor stage 1102C. The system 1200 includes two heat exchangers 902A and 902B each configured to receive and exchange heat between the two fluid streams 404 and 406 flowing through the expander 102 and the compressor 402. The system 1200 may include the flowpath 1104 between the pair of stages 202A and 202B of the multi-stage reciprocating expander 102 and the flowpath 1106 between the pair of stages 1102A and 1102B of the multi-stage compressor 402, both flowpaths 1104 and 1106 passing through the heat exchanger 902A. Similarly, the system 1200 may include a flowpath 1202 between the pair of stages 202B and 202C of the multi-stage reciprocating expander 102, this flowpath 1202 passing through the heat exchanger 902B. The system 1200 may also include a flowpath 1204 between the pair of stages 1102B and 1102C of the multi-stage compressor 402, this flowpath 1204 passing through the heat exchanger 902B.

While various embodiments of a reciprocating expander and system were provided in the foregoing description, those skilled in the art may make modifications and alterations to these aspects without departing from the scope and spirit of the invention. For example, it is to be understood that this disclosure contemplates that, to the extent possible, one or more features of any aspect can be combined with one or more features of any other aspect. As another non-limiting specific example, because natural gas is often odorless, as those of ordinary skill in the art will appreciate it is customary to add an odorant, such as ethyl mercaptan, so that a gas leak can be detected anywhere the gas is being processed or consumed. Therefore, such an odorant can be added to any of the gas products produced in accordance with the present invention. Accordingly, the foregoing description is intended to be illustrative rather than restrictive. The invention described hereinabove is defined by the appended claims, and all changes to the invention that fall within the meaning and the range of equivalency of the claims are to be embraced within their scope.

What is claimed is:

1. A system, comprising:
a reciprocating expander, comprising:
a piston disposed in a chamber;
a crankshaft;
a connector rod coupled between the piston and the crankshaft and configured to transfer torque to the crankshaft in response to movement of the piston in the chamber; and
a fluid inlet and a fluid outlet on one side of the piston;
a first flowpath coupled between a wellbore and the reciprocating expander and configured to communicate gas from the wellbore into the fluid inlet of the reciprocating expander at a first pressure; and
a second flowpath coupled between the reciprocating expander and downstream equipment and configured to communicate the gas from the reciprocating expander toward the downstream equipment at a second pressure, the second pressure being lower than the first pressure.

2. The system of claim 1, wherein the first pressure is at least 1,500 psi.

3. The system of claim 1, wherein the reciprocating expander is a multi-stage reciprocating expander having a second piston disposed in a second chamber, a second crankshaft, a second connector rod, a second fluid inlet, and a second fluid outlet, wherein the fluid outlet is configured to output the gas to the second fluid inlet at an intermediate pressure, the intermediate pressure being between the first pressure and the second pressure.

4. The system of claim 3, further comprising a heat exchanger disposed between the fluid outlet and the second fluid inlet, wherein the heat exchanger is configured to heat the gas flowing between the fluid outlet and the second fluid inlet via ambient air or another fluid.

5. The system of claim 3, further comprising:
a compressor coupled to the reciprocating expander; and
a heat exchanger disposed between the fluid outlet and the second fluid inlet, wherein the heat exchanger is configured to heat the gas flowing between the fluid outlet and the second fluid inlet via fluid moving through the compressor.

6. The system of claim 1, further comprising a compressor coupled to the reciprocating expander and configured to receive operating power from the reciprocating expander.

7. The system of claim 6, further comprising a generator that is coupled to the crankshaft of the reciprocating expander and configured to generate electricity used to electrically power the compressor.

8. The system of claim 6, wherein the compressor is physically coupled to the crankshaft of the reciprocating expander such that the reciprocating expander mechanically powers the compressor.

9. The system of claim 8, further comprising a generator that is coupled to the crankshaft of the reciprocating expander and configured to generate electricity used to electrically power one or more components of the downstream equipment or to supply electricity to a grid.

10. The system of claim 8, further comprising a generator that is coupled to the crankshaft of the reciprocating expander and configured to generate electricity used to power an electrolysis process for generating hydrogen gas, wherein the hydrogen gas is input to the compressor.

11. The system of claim 1, further comprising one or more pieces of conditioning equipment coupled along the first flowpath and configured to condition the gas output from the wellbore for input to the reciprocating expander.

12. The system of claim 1, wherein the downstream equipment comprises at least one of a compressor, a pipeline, a compressed natural gas (CNG) filling station, liquefied natural gas (LNG) production equipment, an electrolysis process, heating/cooling equipment, or an electric grid.

13. A system, comprising:
a reciprocating expander, comprising:
a piston disposed in a chamber;
a crankshaft;
a connector rod coupled between the piston and the crankshaft and configured to transfer torque to the crankshaft in response to movement of the piston in the chamber; and
a fluid inlet and a fluid outlet on one side of the piston,
wherein the reciprocating expander is configured to receive fluid at a first pressure and to output the fluid at a second pressure, the second pressure being lower than the first pressure; and
a compressor connected to the reciprocating expander, wherein the compressor receives operating power from the reciprocating expander to compress another fluid stream.

14. The system of claim 13, wherein:
the reciprocating expander is a multi-stage reciprocating expander having multiple sets of pistons, crankshafts, and connector rods, and
the system further comprises a heat exchanger coupled between at least two stages of the multi-stage reciprocating expander to heat the fluid flowing through the multi-stage reciprocating expander via ambient air or another fluid.

15. The system of claim 13, wherein:
the reciprocating expander is a multi-stage reciprocating expander, and
the compressor is a multi-stage compressor.

16. The system of claim 15, further comprising a heat exchanger, wherein:
a flowpath between a first pair of stages of the multi-stage reciprocating expander passes through the heat exchanger, and
a flowpath between a first pair of stages of the multi-stage compressor passes through the heat exchanger.

17. The system of claim 16, further comprising a second heat exchanger, wherein:
a flowpath between a second pair of stages of the multi-stage reciprocating expander passes through the second heat exchanger, and
a flowpath between a second pair of stages of the multi-stage compressor passes through the second heat exchanger.

18. A system, comprising:
a reciprocating expander comprising a first reciprocating expander stage and a second reciprocating expander stage,
wherein the first reciprocating expander stage has a first fluid inlet and a first fluid outlet, and the second reciprocating expander stage has a second fluid inlet and a second fluid outlet;
a heat exchanger coupled between the first fluid outlet and the second fluid inlet, wherein the heat exchanger is configured to raise the temperature of gas flowing from the first fluid outlet to the second fluid inlet via heat exchange with ambient air or another fluid
a first flowpath coupled to the reciprocating expander for providing gas from a wellbore to the reciprocating expander; and
a second flowpath coupled to the reciprocating expander for providing gas from the reciprocating expander to downstream equipment at a second pressure.

19. The system of claim 18, wherein the heat exchanger is fluidly coupled to at least one of a dehydrator or a CO₂ removal system configured to supply a temperature swing adsorption (TSA) regeneration gas to the heat exchanger, wherein the heat exchanger is configured to raise the temperature of gas flowing from the first fluid outlet to the second fluid inlet via heat exchange with the TSA regeneration gas.

20. The system of claim 18, further comprising a compressor coupled to the reciprocating expander, wherein the compressor is configured to receive operating power from the reciprocating expander.

21. A system, comprising:
an expander;
a compressor coupled to the expander and configured to receive operating power from the expander;
a generator coupled to the expander and configured to generate electricity via rotation of the generator by the expander; and
one or more components of electrolysis equipment coupled to the generator and configured to receive the electricity from the generator and to generate hydrogen gas via the electricity, wherein:
the electrolysis equipment is coupled to the compressor for inputting the hydrogen gas generated via the electrolysis equipment into the compressor, and
the compressor compresses the hydrogen gas.
